(19) United States
(12) Patent Application Publication
(10) Pub. No.: US 2023/0152148 A1
(43) Pub. Date: May 18, 2023

(54) Coffee Scale

(71) Applicant: Dongguan Boheng Electronics Co., Ltd., Dongguan (CN)

(72) Inventor: Tian Dai, Dongguan (CN)

(21) Appl. No.: 17/527,194

(22) Filed: Nov. 16, 2021

(51) Int. Cl. G01G 19/52; A47J 31/44; G01G 21/28

(52) U.S. Cl. CPC G01G 19/52; A47J 31/4403; G01G 21/283

(57) ABSTRACT

A coffee scale includes a weighing mechanism and a display mechanism separated from said weighing mechanism; the weighing mechanism and said display mechanism is respectively provided with a first magnetic piece and a second magnetic piece with opposite magnetic pole; or one of said first magnetic piece and said second magnetic piece is a magnet and the other of said first magnetic piece and said second magnetic piece is made of iron material, so that said weighing mechanism and said display mechanism can be attracted together in an action of magnetic force.

### FIELD OF THE INVENTION

The invention relates to a weighting device technical field, more particularly relates to a kind of coffer scale.

### BACKGROUND OF THE INVENTION

Coffee scale is used to measure a weight of coffee power, a flow rate of water and a water amount adding to the coffee power in the process of brewing coffee, thereby controlling the flow rate of water and the water amount, and the ratio of the coffer power and the water so as to accurately control the consistency and taste of coffee.

The common coffee scale has a display screen on the scale plate, where the weighed value is displayed. When brewing coffer with this kind of coffer scale, the user must add water and coffer power into the container placed on the scale plate, and stir them while observing the weighed value displayed on the display screen. Sometimes, the display screen is blocked, the user can not observe the weighted value, which easily causes mistakes, for example, sprinkling water on the scale plate or overturning the container, or pouring too much water.

Accordingly, it urgently needs to develop a new kind of coffee scale to overcome the deficiencies of the prior art.

### SUMMARY OF THE INVENTION

To overcome the deficiencies of the prior art, the present invention provides a coffee scale, which includes a weight mechanism and a display mechanism separated from the weight mechanism, the display mechanism can be attracted to the weight mechanism at any place suitable for observing, thereby resolving the deficiencies of the prior art.

The technologies in the present invention are as follows:

A coffee scale includes a weighing mechanism and a display mechanism separated from the weighing mechanism. The weighing mechanism and the display mechanism are respectively provided with a first magnetic piece and a second magnetic piece. The first magnetic piece and the second magnetic piece are made of magnet, or one is made of magnet and the other is made of iron or iron alloy, so that the weighing mechanism and the display mechanism can be attracted together in an action of magnetic force.

The weighing mechanism has a first closed shell, the first magnetic piece is disposed on a surface of the first closed shell or in the first closed shell.

The weighing mechanism has a few of the first magnetic pieces respectively on the surface of the first closed shell or in the first closed shell.

The display mechanism has a second closed shell, the second magnetic piece is disposed on a surface of the second closed shell or in the second closed shell.

The weighting mechanism also includes a first inner shell in the first closed shell. A main control board, a first power supply, a first USB interface, and a first weighing sensor are arranged in the first inner shell. The main control board electrically connects with the first power supply, the first USB interface, and the first weighing sensor.

The main control board is provided with a weight module for measuring weight, a volume module for measuring volume, a speed module for measuring the water rate, a first power module for measuring electricity, a first wireless signal module for detecting a wireless signal, a sound broadcast module for broadcasting sound, and a first switch.

The top of the first closed shell is provided with a first display screen comprising a first weight display window, a first, volume display window, a first speed display window, a first power display window, a first wireless signal display window, a first sound broadcast window, and a first switch window, etc.

The display mechanists includes a second inner shell in the second closed shell. A PCB control board, a second power supply, and a second USB interface are disposed in the second inner shell. The PCB control board electrically connects with the second power supply and a second USB interface.

The PCB control board is provided with a second power supply module for measuring power of electricity, a second wireless power supply signal module for measuring wireless signal, and a second switch button.

The second closed shell is provided with a second display screen comprising a second weight display window, a second volume display window, a second speed display window, a second power display window, a second wireless signal display window, and a second switch button window.

The main control board and the PCB control board are respectively provided with a first signal receiving and sending unit and a second signal receiving and sending unit, with the function of receiving and sending signal, and synchronizing data interaction through wireless communication.

The main control board is provided with a first function module, and the first display screen is provided with a first function setting interface; the PCB control board is provided with a second function module, the second display screen further comprises a second function, setting interface.

The advantages of the present invention are as follows: the coffee scale in the present invention separates the display mechanism from the weighting mechanism, and the two can be attracted together by magnetic suction so that the display mechanism can be absorbed to the position, convenient for observing, of the weighting mechanism. When the coffee scale is used for brewing coffee, the user can know the weight change of the coffer container by observing the display screen and control the flow rate of water and the water amount at anv time, thereby ensuring the consistency and taste of the coffee.

### BRIEF DESCRIPTION OF THE DRAWINGS

FIG. 1 is a perspective view of the coffee scale according to the present invention.

FIG. 2 is a decomposition view of the weighting mechanism 10 of the coffee scale according to the present invention.

FIG. 3 is a decomposition view of the display mechanism 20 of the coffee scale according to the present invention.

FIG. 4 is a schematic diagram of the control system of the coffee scale according to the present invention.

### DETAILED DESCRIPTION OF ILLUSTRATED EMBODIMENTS

In order to describe the object of the invention, the technical scheme and the technical effect more clear, the invention is further explained in combination with specific embodiments. It should be understood that the specific embodiments described herein are used only to interpret the present invention and are not used to define the present invention.

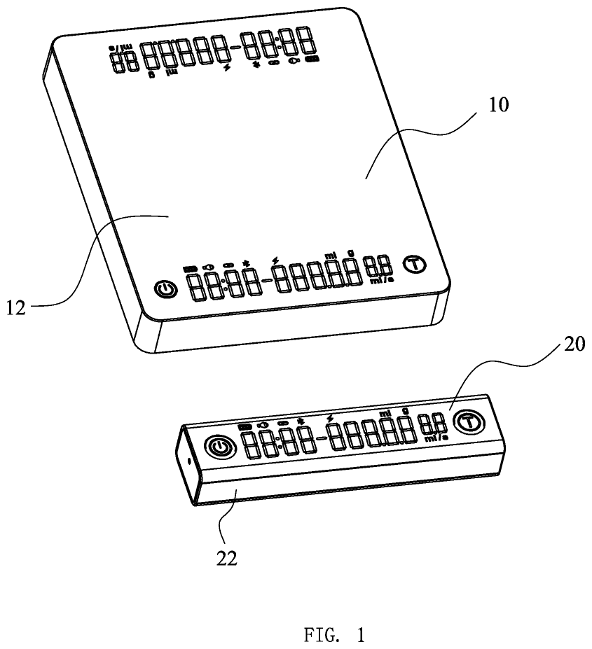

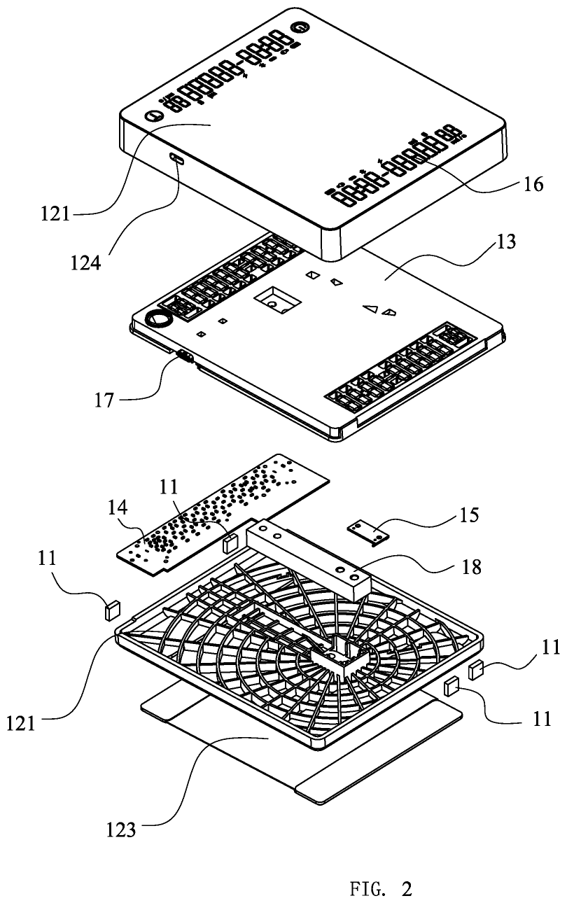

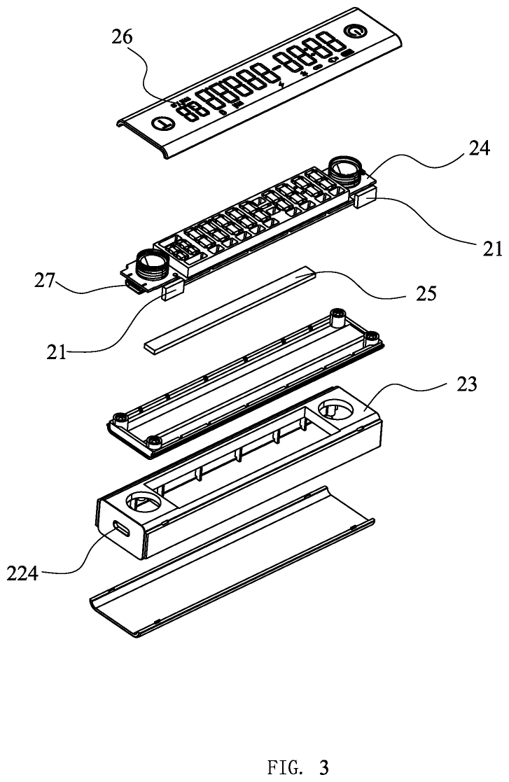

Referring to FIG. 1, FIG. 2 and FIG. 3, a coffee scale includes a weighting mechanism 10 with a first magnetic piece 11 and a display mechanism 20 with a second magnetic piece 12. The display mechanism 20 separates from the weighting mechanism 10. The first magnetic piece 11 and the second magnetic piece 12 are made of magnet, or one is made of magnet, the other is made of iron or iron alloy that can be attracted by a magnet, so that the weighing mechanism 10 and the display mechanism 20 can be attracted together in the action of magnetic force. When a user brews coffee with the coffee scale, a container is placed on the weighting mechanism 10, the display screen can be put a position, convenient for observing, of the weighting mechanism 20. So that the user can add water and coffer power into the container and stir them, while observing the change of the weighted values displaying on the display screen. The user can control the flow rate of water and the water amount, thereby ensuring the consistency and taste of the coffee.

The weighing mechanism 10 has a first closed shell 12, the first magnetic piece 11 is disposed on the surface of the first closed shell 12 or in the first closed shell 12. It is should be understood that if the first closed shell 12 is made from plastics, whether that the first magnetic piece is disposed on the surface of the first closed shell 12 or in the first closed shell 12 will not affect the magnetic attraction. In the preferred embodiments, for achieving the objection that the display screen 20 can be attracted at different positions of the weighting mechanism 10, the weighting mechanism 10 has a few of the first magnetic pieces 11, which are respectively disposed on the surface of the first closed shell 12 or in the first closed shell 12.

The display mechanism 20 has a second closed shell 22 disposed on the surface of the second closed shell 22 or in the second closed shell 22. It should be understood that if the second closed shell 22 is made from plastics, whether that the second magnetic piece 22 is disposed on the surface of the second closed shell 22 or in the second closed shell 22 will not affect the magnetic attraction.

In a preferred embodiment, one of the first closed shell 12 and the second closed shell 22 is made of iron or iron alloy, the other of the first closed shell 12 and the second closed shell 22 is provided with a magnet, thus, the first closed shell 12 can be attracted on any position of the surface of the second closed shell 22.

The first closed shell 12 of the weighing mechanism 10 has a housing 121 and a cover 122 that cooperate with each other to seal connection. The weighing mechanism 10 also includes an inner shell 13 disposed in the first closed shell 12. A main control board 14, a first power supply 15, a first USB interface 17, and a first weighing sensor 18 are arranged in the first inner shell 12. The main control board 14 electrically connects with the first power supply 15, the first USB interface 17, and the first weighing sensor 18.

The first power supply 15 is a disposable battery or a rechargeable battery. The first weighing sensor 18 is used to measure the weight of items on the weight mechanism 10 and send signal to a display screen in the first display screen 16. The first USB interface 17 is used to charge the first power supply 15. The first USB interface 17 is arranged on a side of the inner shell 13. The first closed shell 12 is provided with a through hole 124 corresponding to the first USB interface 17, so that an external power can pass through the through hole 124 to connect with the first USB interface 17.

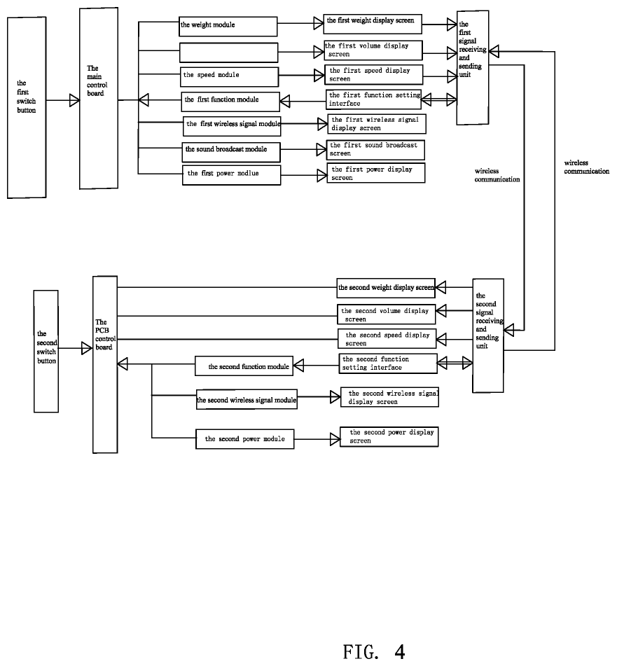

Referring to FIG. 4, the main control board 14 is provided with a weight module for measuring weight, a volume module for measuring volume, a speed module for measuring the flow rate of water, a first power module for measuring electricity, a first wireless signal module for detecting a wireless signal, and a sound broadcast module for broadcasting sound, and a first switch.

The cover 121 is provided with a display screen 16 comprising a first weight display window, a first volume display window, a first speed display window, a first power display window, a first wireless signal display window, a first sound broadcast window, and a first switch window, etc. The measuring results of the weight module, the volume module, the speed module, the power module, the wireless signal module, the sound broadcast module are converted to values by a first converter and displayed through the first volume display window, the first weight display window, the first power display window and the first wireless signal display window. The first sound broadcast window is used for broadcasting the values displayed in the above display windows.

The wireless signal module can apply Bluetooth, WiFi, ZigBee, short-range communication technology NFC, home RF, infrared communication technology IrDA, UWB, Z-Wave and other modes.

The housing 121 is provided with a few of soft glue pads 123.

The display mechanism 20 also includes a second inner shell 23 in the second closed shell 21. A PCB control board 24, a second power supply 25, and a second USB interface 27 are disposed in the second inner shell 23. The PCB control board 24 electrically connects with the second power supply 25 and a second USB interface 27. The second power supply 25 is a disposable battery or a rechargeable battery. The second USB interface 27 is used to charge the second power supply 25. The second closed shell 22 is provided with a through hole 224 corresponding to the second USB interface 27, so that an external power can pass through the through hole 224 to connect with the second USB interface 27.

The PCB control board 44 is provided with a second power module for measuring power of electricity and a second wireless, power signal module for measuring wireless signal, and a second switch button.

The second closed shell 22 is provided with a second display screen 26 comprising a second weight display window, a second volume display window, a second speed display window, a second power display window, a second wireless signal display window, and a second switch button window.

The measuring results of the second power supply module and the second wireless power supply signal module are converted to values by a second converter and displayed by the second power display window and the second wireless signal display window

The main control board 14 and the PCB control board 24 are respectively provided with a first signal receiving and sending unit and a second signal receiving and sending unit, with the function of receiving and sending signal, and synchronizing signal interaction through wireless communication. The first signal receiving and sending unit is used for sending in real time the signal, displayed in the first weight display window, the first volume display window, and the first speed display window, to the second signal receiving and sending unit. After the second signal receiving and sending unit receives the signal, it sends the signal to the second weight display window, the second volume display window, and the second speed display window.

Preferably, the main control board is provided with a first function module, and the first display screen 16 is provided with a first function setting interface used for inputting various functional parameters, such as time, temperature, etc., and starting the first function module to operate following the parameters.

Preferably, the PCB control board is provided with a second function module, the second display screen 26 further comprises a second function setting interface used for inputting various functional parameters, such as time, temperature, etc., and starting the first function module to operate following the parameters.

The first function setting interface sends the parameters input by the users to the first signal receiving and sending unit, which receives the parameters and synsynchronous sends to the second signal receiving and sending unit, the second signal receiving and sending unit receives and sends the parameters to the second function setting interface, the second function setting interface starts the second function module to run according to the parameters, thereby achieving the synsynchronous control of the weighing mechanism and the display mechanism.

Preferably, the user can use the display mechanism to synsynchronous control the weighting mechanism. The user input parameters through the second functional setting interface, the second functional setting interface sends the parameters to the second signal receiving and sending unit. The second signal receiving and sending, unit synsynchronous receives the parameters and sends to the first signal receiving and sending unit. The first signal receiving and sending unit receives and sends the parameters the first functional interface, the first functional interface starts the first functional module to run according to the parameters, thereby achieving synsynchronous control of the weighing mechanism and the display mechanism.

The above content is a further detailed description of the present invention in combination with the specific preferred embodiments, and it cannot be determined that a specific implementation of the present invention is limited to these descriptions only. For those skilled in the technical art according to the invention, the architectural form can be flexible and derive a series of products without, departing from the conception of the invention. Only a number of simple inferences or replacements shall be deemed to fall within the protection scope of the submitted claims determined by the present invention.

What is claimed is:

1. A coffee scale, comprising a weighing mechanism and a display mechanism separated from said weighing mechanism; said weighing mechanism and said display mechanism are respectively provided with a first magnetic piece and a second magnetic piece; said first magnetic piece and said second magnetic piece are made of magnet, or one of said first magnetic piece and said second magnetic piece is made of magnet, the other of said first magnetic piece and said second magnetic piece is made of iron or iron alloy, so that said weighing, mechanism and said display mechanism can be attracted together in an action of magnetic force.

2. The coffee scale according to claim 1, wherein said weighing mechanism has a first closed shell, said first magnetic piece is disposed on a surface of said first closed shell or in said first closed shell.

3. The coffee scale according to claim 2, wherein said weighing mechanism has a few of said first magnetic pieces respectively disposed on said surface of said first closed shell or in said first closed shell.

4. The coffee scale according to claim 2, wherein said display mechanism has a second closed shell, said second magnetic piece is disposed on said surface of said second closed shell or in said second closed shell.

5. The coffee scale according to claim 1, wherein said weighting mechanism also includes a first inner shell in said first closed shell; a main control board, a first power supply, a first USB interface, and a first weighing sensor are arranged in said first inner shell; said main control board electrically connects with said first power supply, said first USB interface, and said first weighing sensor.

6. The coffee scale according to claim 5, wherein said main control board is provided with a weight module for measuring weight, a volume module for measuring volume, a speed module for measuring said pouring water rate, a first power module for measuring electricity, a first wireless signal module for detecting a wireless signal, and a sound broadcast module for broadcasting sounds, and a first switch;
a top of said first closed shell is provided with a first display screen comprising a first weight display window, a first volume display window, a first speed display window, a first power display window, a first wireless signal display window, a first sound broadcast window, and a first switch window.

7. The coffee scale according to claim 6, wherein said display mechanism includes a second inner shell in said second closed shell; a PCB control board, a second power supply, and a second USB interface are disposed in said second inner shell; said PCB control board electrically connects with said second supply and a second USB interface.

8. The coffee scale according to claim 7, wherein said PCB control board is provided with a second power supply module for measuring power of electricity, a second wireless power supply signal module for measuring wireless signal, and a second switch;
said second closed shell is provided with a second display screen comprising a second weight display window, a second volume display window, a second speed display window, a second power display window, a second wireless signal display window, and a second switch window.

9. The coffee scale according to claim 8, wherein said main control board and said PCB control board are respectively provided with a first signal receiving and sending unit and a second signal receiving and sending unit, with a function of receiving and sending signal, and synchronizing signal interaction through wireless communication.

10. The coffee scale according to claim 9, wherein said main control board is provided with a first function module, and said first display screen is provided with a first function setting interface; said PCB control board is provided with a second function module, said second display screen further comprises a second function setting interface.
